(19) United States
(12) Patent Application Publication
(10) Pub. No.: US 2023/0219286 A1
(43) Pub. Date: Jul. 13, 2023

(54) THREE-DIMENSIONAL OBJECT AND ADDITIVE MANUFACTURING METHOD OF THREE-DIMENSIONAL OBJECT

(71) Applicant: KABUSHIKI KAISHA TOSHIBA, Tokyo (JP)

(72) Inventors: Naoya AKAISHI, Yamato Kanagawa (JP); Satoshi SAYAMA, Yokohama Kanagawa (JP)

(21) Appl. No.: 18/059,176

(22) Filed: Nov. 28, 2022

(30) Foreign Application Priority Data
Jan. 12, 2022 (JP) 2022-003147

(51) Int. Cl. B29C 64/124; B33Y 80/00; B29C 64/393; B22F 10/28; B33Y 10/00

(52) U.S. Cl. CPC B29C 64/124; B33Y 80/00; B29C 64/393; B22F 10/28; B33Y 10/00

(57) ABSTRACT

According to one embodiment, a three-dimensional object includes a periodic structure. The periodic structure includes a plurality of unit objects which form a plurality of stepped structures connected to each other. In each of the stepped structures, the unit objects are connected together in a stepwise form along a polygonal spiral trajectory around a unit axis. In each of the stepped structures, the unit axis extends in a first direction. The stepped structures are each provided with a unit channel extending along the connected unit objects of the stepwise form. The periodic structure is provided with a channel in communication with an outside of the periodic structure, the channel including the unit channels.

### CROSS-REFERENCE TO RELATED APPLICATIONS

This application is based upon and claims the benefit of priority from Japanese Patent Application No. 2022-003147, filed on Jan. 12, 2022, the entire contents of which are incorporated herein by reference.

### FIELD

Embodiments described herein relate generally to a three-dimensional object and an additive manufacturing method of a three-dimensional object.

### BACKGROUND

Three-dimensional objects with channels having a large inner surface area through which fluid can pass are produced for, for example, catalysts, gas-liquid separators, radiators, or other applications. As an example, such three-dimensional objects with complex channels can be produced by additive manufacturing.

Additive manufacturing devices such as a three-dimensional printer implement additive manufacturing. For example, the additive manufacturing device produces a three-dimensional object by repeatedly forming a material layer and curing a part of the material of the layer with a laser beam. The laser beam sinters powder materials or cures photocurable resins containing powder materials, for example.

A three-dimensional object with complex channels is exemplified by a lattice. It is however difficult to form channels having a larger inner surface area in a simple lattice.

### BRIEF DESCRIPTION OF THE DRAWINGS

FIG. 1 is an exemplary perspective view illustrating a three-dimensional object according to an embodiment;

FIG. 2 is an exemplary perspective view of a part of a periodic structure of the embodiment;

FIG. 3 is an exemplary plan view of a part of the periodic structure of the embodiment;

FIG. 4 is an exemplary cross-sectional view partially illustrating the periodic structure of the embodiment;

FIG. 5 is an exemplary cross-sectional view schematically illustrating a three-dimensional printer of the embodiment;

FIG. 6 is an exemplary diagram schematically illustrating various data in the embodiment; and

FIG. 7 is an exemplary plan view schematically illustrating a part of a layer at an additive manufacturing step of the embodiment.

### DETAILED DESCRIPTION

According to one embodiment, a three-dimensional object includes a periodic structure. The periodic structure includes a plurality of unit objects which form a plurality of stepped structures connected to each other. In each of the stepped structures, the unit objects are connected together in a stepwise form along a polygonal spiral trajectory around a unit axis. In each of the stepped structures, the unit axis extends in a first direction. The stepped structures are each provided with a unit channel extending along the connected unit objects of the stepwise form. The periodic structure is provided with a channel in communication with an outside of the periodic structure, the channel including the unit channels.

### Embodiments

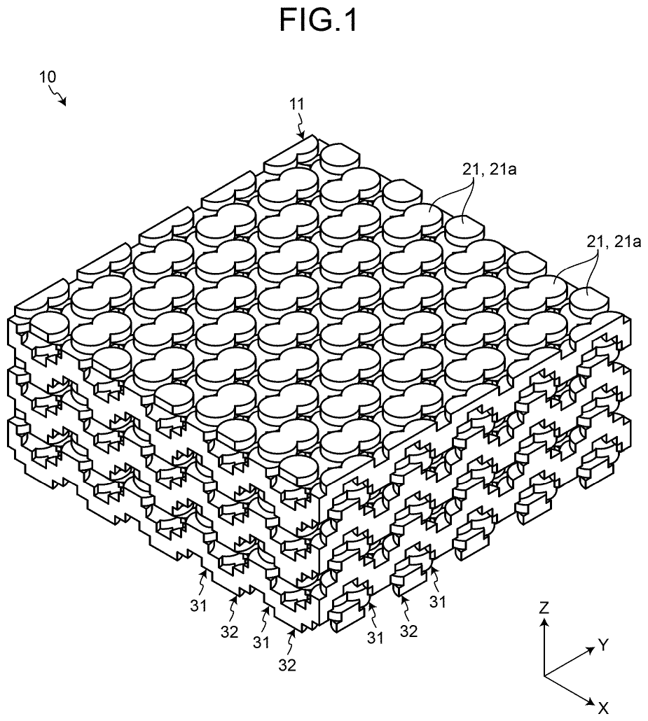

An embodiment will be described below with reference to FIGS. 1 to 7. In the present specification, by default, vertical upward is defined as an upper direction and vertical downward is defined as a lower direction. In the present specification, components according to the embodiment and the description of such components may be described in an expression as plural. The components and descriptions thereof are examples, and the present embodiment are not limited by expressions herein. The components may also be identified by different names from those used herein. The components may also be described by different expressions from those used herein.

FIG. 1 is an exemplary perspective view illustrating a three-dimensional object 10 according to an embodiment. The three-dimensional object 10 is used for, for example, catalysts, gas-liquid separators, radiators, or other applications. The three-dimensional object 10 is manufactured by, for example, additive manufacturing. The three-dimensional object 10 may be manufactured by other methods.

As illustrated in each of the figures, X, Y, and Z axes are defined in the present specification for convenience. The X, Y, and Z axes are orthogonal to each other. The X axis is provided along the width of the three-dimensional object 10. The Y axis is provided along the length of the three-dimensional object 10. The Z axis is provided along the height of the three-dimensional object 10.

Furthermore, X, Y, and Z directions are defined in the present specification. The X direction is a direction along the X axis and includes a +X direction that is indicated by an arrow on the X axis, and a −X direction that faces an opposite direction to the direction indicated by the arrow on the X axis. The Y direction is a direction along the Y axis and includes a +Y direction that is indicated by an arrow on the Y axis, and a −Y direction that faces an opposite direction to the direction indicated by the arrow on the Y axis. The Z direction is a direction along the Z axis and includes a +Z direction that is indicated by an arrow on the Z axis, and a −Z direction that faces an opposite direction to the direction indicated by the arrow on the Z axis.

For convenience, the +X direction may be referred to as the right direction, the −X direction may be referred to as the left direction, the +Y direction may be referred to as the backward direction, the −Y direction may be referred to as the forward direction, the +Z direction may be referred to as the upper direction, and the −Z direction may be referred to as the lower direction. However, a position, orientation, aspect of use, and other conditions are not limited by each of the expressions of upper, lower, left, right, front, and back in the present embodiment.

The +Z direction is an example of a first direction. The X direction (+X direction or −X direction) is a direction orthogonal to the +Z direction and is an example of a fourth direction. The Y direction (+Y direction or −Y direction) is a direction orthogonal to the +Z direction and also orthogonal to the X direction, and is an example of a fifth direction.

The three-dimensional object 10 is made of ceramics, for example. The three-dimensional object 10 may be made of another material such as a metal, a resin, or a metal oxide. The three-dimensional object 10 includes a periodic structure 11. The three-dimensional object 10 may include other components.

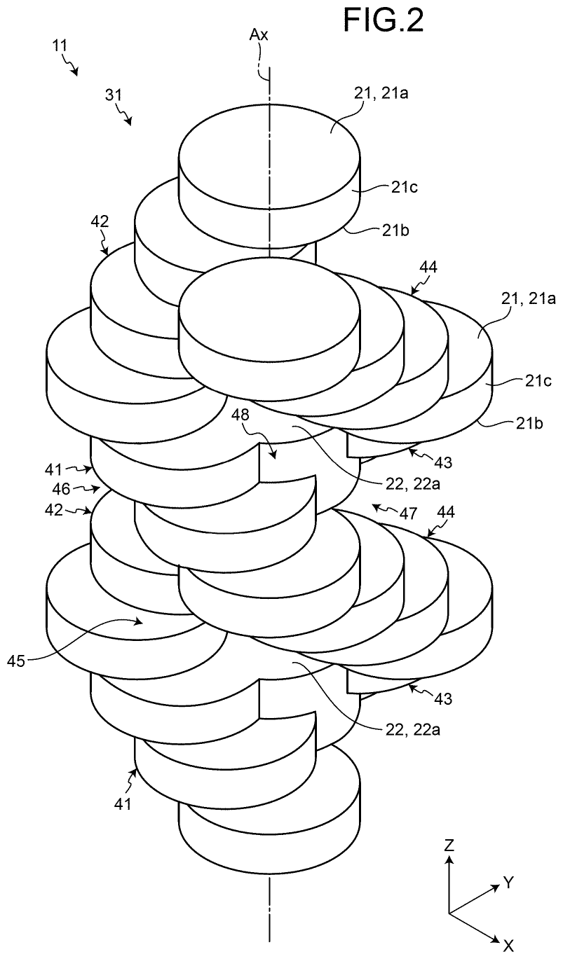

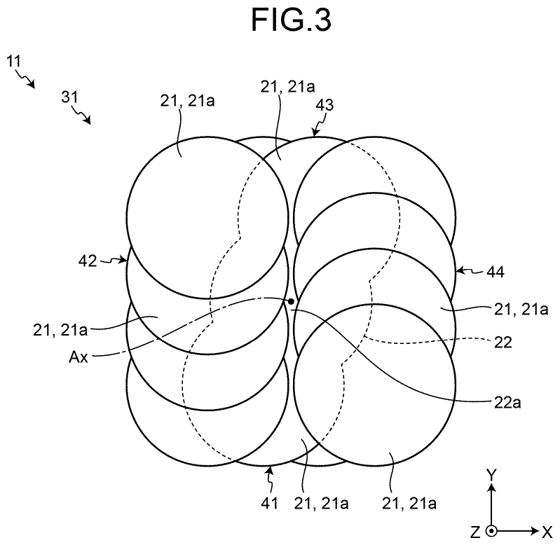

FIG. 2 is an exemplary perspective view of a part of the periodic structure 11 of the present embodiment. FIG. 3 is an exemplary plan view of a part of the periodic structure 11 of the present embodiment. As illustrated in FIGS. 2 and 3, the periodic structure 11 has a plurality of columnar members 21 and a plurality of connections 22. Each of the columnar members 21 is an example of a unit object and can also be referred to as a unit member.

The columnar members 21 and the connections 22 have a substantially cylindrical shape extending approximately in the Z direction. The shapes of the columnar members 21 and the connections 22 are not limited to this example. The columnar members 21 and the connections 22 may have different shapes from each other.

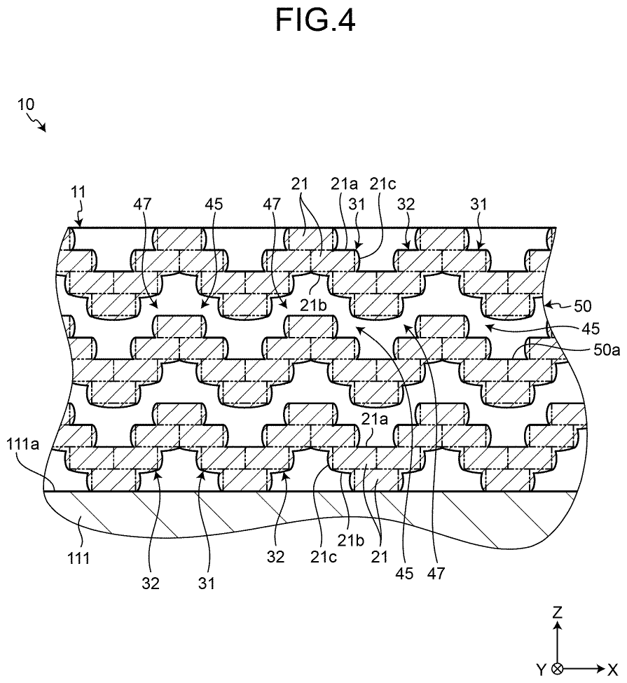

FIG. 4 is an exemplary cross-sectional view partially illustrating the periodic structure 11 of the present embodiment. As illustrated in FIG. 4, each of the columnar members 21 has an upper surface 21a, a lower surface 21b, and a side surface 21c. The upper surface 21a is an example of a flat surface.

The upper surface 21a is a substantially flat circular surface. The upper surface 21a may have another shape such as a rectangle. The upper surface 21a faces approximately in the +Z direction. The lower surface 21b is opposite to the upper surface 21a. The side surface 21c extends between the upper surface 21a and the lower surface 21b.

The lower surface 21b is a substantially circular surface. However, at least one of the columnar members 21 has a curved lower surface 21b protruding approximately in the −Z direction. The lower surface 21b is not limited to this example. For example, a lowermost one of the columnar members 21 may have a substantially flat lower surface 21b.

The side surface 21c is a substantially cylindrical curved surface. However, at least one of the columnar members 21 has a curved side surface 21c protruding in a direction approximately orthogonal to or intersecting with the Z direction. The side surface 21c is not limited to this example.

As illustrated in FIG. 2, each of the connections 22 has an upper surface 22a. The upper surface 22a is a substantially flat circular surface as the upper surface 21a of the columnar member 21, and faces in the +Z direction. The shape of the connections 22 is not limited to this example.

As illustrated in FIG. 1, the columnar members 21 form a plurality of stepped structures 31 and 32. FIGS. 2 and 3 illustrate one stepped structure 31 of the stepped structures 31 and 32. The stepped structures 32 are mirror symmetric with respect to the stepped structures 31 in a direction orthogonal to the Z axis.

As illustrated in FIG. 2, in each of the stepped structures 31 and 32, the columnar members 21 are connected together in a stepwise form, following a polygonal spiral trajectory around a unit axis Ax. The unit axis Ax is an axis of the spiral trajectory in each of the stepped structures 31 and 32. That is, the periodic structure 11 has a plurality of unit axes Ax corresponding to the stepped structures 31 and 32. The unit axes Ax in the stepped structures 31 and 32 extend in the Z direction (+Z direction). In other words, the unit axes Ax extend substantially in parallel in the Z direction.

In the present embodiment, the columnar members 21 are connected together in a stepwise form following double spiral trajectories around one unit axis Ax. The columnar members 21 may be connected to each other along a single spiral trajectory or along triple or more spiral trajectories.

As illustrated in FIG. 3, in the present embodiment, the columnar members 21 are connected together in a stepwise form along a rectangular spiral trajectory. In other words, when viewed in the Z direction, the columnar members 21 are connected to each other along a rectangular trajectory. The columnar members 21 are not limited to this example, and may be connected together in a stepwise form along a hexagonal, octagonal, or other polygonal spiral trajectory.

At least one of the columnar members 21 is connected to the upper surface 21a of another one of the columnar members 21. The upper surface 21a of one columnar member 21 is connected to the lower surface 21b of another columnar member 21. As illustrated in FIG. 4, the upper surface 21a of the uppermost one of the columnar members 21 may not be connected to another columnar member 21. In addition, the lower surface 21b of the lowermost one of the columnar members 21 may not be connected to another columnar member 21.

Due to the stepwise form of the connected columnar members 21, the upper surfaces 21a of the columnar members 21 are at least partially not connected to other objects and other parts but exposed. Likewise, the lower surfaces 21b of the columnar members 21 are at least partially not connected to other objects and other parts but exposed.

As illustrated in FIG. 2, each of the stepped structures 31 and 32 along the rectangular spiral trajectory includes a plurality of stepped portions 41, 42, 43, and 44. In other words, the columnar members 21 of each of the stepped structures 31 and 32 form the stepped portions 41, 42, 43, and 44. In the individual stepped portions 41, 42, 43, and 44 the columnar members 21 are connected together in a stepwise form.

As illustrated in FIG. 3, the columnar members 21 of the stepped portion 41 are aligned in the X direction when viewed in the Z direction (+Z or −Z direction). The columnar members 21 of the stepped portion 41 are aligned in a diagonal direction (upper left) between the −X direction and the +Z direction. Thus, in the stepped portion 41, the center of one columnar member 21 is apart from the center of another columnar member 21 connected to the upper surface 21a of the one columnar member 21 in the +X direction.

The columnar members 21 of the stepped portion 42 are aligned in the Y direction when viewed in the Z direction. The columnar members 21 of the stepped portion 42 are aligned in a diagonal direction (diagonally backward) between the +Y direction and the +Z direction. Thus, in the stepped portion 42, the center of one columnar member 21 is apart from the center of another columnar member 21 connected to the upper surface 21a of the one columnar member 21 in the −Y direction.

The columnar members 21 of the stepped portion 43 are aligned in the X direction when viewed in the Z direction. The columnar members 21 of the stepped portion 43 are aligned in a diagonal direction (upper right) between the +X direction and the +Z direction. Thus, in the stepped portion 43, the center of one columnar member 21 is apart from the center of another columnar member 21 connected to the upper surface 21a of the one columnar member 21 in the −X direction.

The columnar members 21 of the stepped portion 44 are aligned in the Y direction when viewed in the Z direction. The columnar members 21 of the stepped portion 44 are aligned in a diagonal direction (diagonally forward) between the −Y direction and the +Z direction. Thus, in the stepped portion 44, a center of one columnar member 21 is separated apart from a center of another columnar member 21 connected to an upper surface 21a of the one columnar member 21 in the +Y direction.

In the stepped structure 31, the uppermost columnar member 21 of one stepped portion 41 is connected to the lowermost columnar member 21 of one stepped portion 42. The uppermost columnar member 21 of the one stepped portion 42 is connected to the lowermost columnar member 21 of one stepped portion 43. The uppermost columnar member 21 of the one stepped portion 43 is connected to the lowermost columnar member 21 of one stepped portion 44. The uppermost columnar member 21 of the one stepped portion 44 may be connected to the lowermost columnar member 21 of another stepped portion 41.

In the stepped structure 32, the lowermost columnar member 21 of one stepped portion 41 is connected to the uppermost columnar member 21 of one stepped portion 42. The lowermost columnar member 21 of the one stepped portion 42 is connected to the uppermost columnar member 21 of one stepped portion 43. The lowermost columnar member 21 of the one stepped portion 43 is connected to the uppermost columnar member 21 of one stepped portion 44. The lowermost columnar member 21 of the one stepped portion 44 may be connected to the uppermost columnar member 21 of another stepped portion 41.

The stepped portions 41, 42, 43, and 44 connected to each other extend along a rectangular spiral trajectory. The rectangular spiral trajectory is, for example, a spiral trajectory along the outer circumference of a virtual quadrangular prism extending along the unit axis Ax.

In the present embodiment, each of the stepped portions 41, 42, 43, and 44 is formed by four columnar members 21 among the columnar members 21. The number of the columnar members 21 that form the stepped portions 41, 42, 43, and 44 is not limited to this example.

One of the columnar members 21 forming the stepped portion 41 also serves as one of the columnar members 21 forming the stepped portion 42. One of the columnar members 21 forming the stepped portion 42 also serves as one of the columnar members 21 forming the stepped portion 43. One of the columnar members 21 forming the stepped portion 43 also serves as one of the columnar members 21 forming the stepped portion 44. One of the columnar members 21 forming the stepped portion 44 may also serve as one of the columnar members 21 forming the stepped portion 41.

In each of the stepped structures 31 and 32, two stepped portions 41 are aligned with spacing in the Z direction. The two stepped portions 41 extend approximately in a parallel manner. The two stepped portions 42 are also aligned with spacing in the Z direction. The two stepped portions 42 extend approximately in a parallel manner.

The two stepped portions 43 are also aligned with spacing in the Z direction. The two stepped portions 43 extend approximately in a parallel manner. The two stepped portions 44 are also aligned with spacing in the Z direction. The two stepped portions 44 extend approximately in a parallel manner.

As illustrated in FIG. 2, each of the stepped structures 31 and 32 is provided with a plurality of unit channels 45, 46, 47, and 48. The unit channel 45 extends between two stepped portions 41. In other words, the unit channel 45 extends between the adjacent columnar members 21 in the Z direction (+Z direction). The unit channel 45 extends substantially in parallel to the stepped portions 41.

The unit channel 46 extends between two stepped portions 42 substantially in parallel to the stepped portions 42. The unit channel 47 extends between two stepped portions 43 substantially in parallel to the stepped portions 43. The unit channel 48 extends between two stepped portions 44 substantially in parallel to the stepped portions 44.

One end of the unit channel 45 is connected to one end of the unit channel 46. The other end of the unit channel 46 is connected to one end of the unit channel 47. The other end of the unit channel 47 is connected to one end of the unit channel 48. The other end of the unit channel 48 may be connected to one end of another unit channel 45. The unit channels 45, 46, 47, and 48 connected to each other extend along a rectangular spiral trajectory. In other words, the unit channels 45, 46, 47, and 48 extend along the columnar members 21 mutually connected in a stepwise form.

As described above, the columnar members 21 are connected together in a stepwise form along double spiral trajectories around one unit axis Ax. Therefore, in each of the stepped structures 31 and 32, two columnar members 21 are aligned in a direction orthogonal to the Z direction. The two columnar members 21 are separated apart from each other in a direction orthogonal to the Z axis.

According to another expression, in each of the stepped structures 31 and 32, an upper surface 21a of one of the columnar members 21 and an upper surface 21a of another one of the columnar members 21 are at approximately the same position (height) in the Z direction. At least two of the columnar members 21, which have the upper surfaces 21a at the same position in the Z direction (+Z direction), are separated apart from each other in a direction orthogonal to the Z direction.

Each of the connections 22 connects between the connected columnar members 21 of a stepwise form along one trajectory of the double spiral trajectories and the connected columnar members 21 of a stepwise form along the other trajectory of the double spiral trajectories. For example, each of the connections 22 mutually connects two columnar members 21 located on a diagonal line passing the unit axis Ax. The upper surface 22a of one connection 22 and the upper surfaces 21a of two columnar members 21 connected through one connection 22 form one plane.

In the present embodiment, a length of each of the connections 22 in the Z direction is about twice a length of each of the columnar members 21 in the Z direction. The connections 22 connects a pair of the columnar members 21 aligned in a direction orthogonal to the Z direction to each other and another pair of columnar members 21 aligned in a direction orthogonal to the Z direction to each other. The connections 22 are not limited to this example.

As illustrated in FIG. 1, the stepped structures 31 and 32 are disposed in a lattice pattern along an X-Y plane and are connected to each other in the X direction and the Y direction. In other words, one of the stepped structures 31 and 32 is connected to another one of the stepped structures 31 and 32 in the X direction and is connected to still another one of the stepped structures 31 and 32 in the Y direction.

In the present embodiment, the stepped structures 31 and stepped structures 32 are alternately formed. In the adjacent stepped structures 31 and 32 in the X direction, the stepped portion 42 or 44 of each stepped structure 31 also serves as the stepped portion 42 or 44 of each stepped structure 32. In the adjacent stepped structures 31 and 32 in the Y direction, the stepped portion 41 or 43 of each stepped structure 31 also serves as the stepped portion 41 or 43 of each stepped structure 32.

As described above, the periodic structure 11 includes the alternately formed, mirror-symmetrical stepped structures 31 and 32. In other words, the stepped structures 31 and 32 are formed periodically to form the periodic structure 11.

As illustrated in FIG. 4, as a result of forming the stepped structures 31 and 32 adjacent to each other in the X direction, the unit channel 45 of the stepped structure 31 and the unit channel 47 of the stepped structure 32 are connected to each other. The unit channel 45 is an example of a first unit passage. The unit channel 47 is an example of a second unit passage.

A direction in which the unit channel 45 extends and a direction in which the unit channel 47 extends intersect with each other. The direction in which the unit channel 45 extends is a direction orthogonal to the Z direction (+Z direction) and is an example of a second direction. The direction in which the unit channel 47 extends is a direction orthogonal to the Z direction (+Z direction) and is an example of a third direction. A direction in which the unit channel 45 extends and a direction in which the unit channel 47 extends intersect with each other.

Similarly, as a result of forming the stepped structures 31 and 32 adjacent to each other in the X direction, the unit channel 47 of the stepped structure 31 and the unit channel 45 of the stepped structure 32 are connected to each other. As a result of forming the stepped structures 31 and 32 adjacent to each other in the Y direction, the unit channel 46 of the stepped structure 31 and the unit channel 48 of the stepped structure 32 are connected to each other. Furthermore, as a result of forming the stepped structures 31 and 32 adjacent to each other in the Y direction, the unit channel 48 of the stepped structure 31 and the unit channel 46 of the stepped structure 32 are connected to each other.

In the present embodiment, the direction in which the unit channel 45 extends and the direction in which the unit channel 47 extends orthogonal to each other. In addition, a direction in which the unit channel 46 extends and a direction in which the unit channel 48 extends orthogonal to each other. The directions in which the unit channels 45, 46, 47, and 48 extend are not limited to this example.

Mutual connection among the unit channels 45, 46, 47, and 48 of the stepped structures 31 and 32 forms a channel 50 in the periodic structure 11. The channel 50 includes the unit channels 45, 46, 47, and 48 that are connected to each other. The channel 50 may include other portions.

The channel 50 opens to an end portion of the periodic structure 11 in each of the +X direction, −X direction, +Y direction, −Y direction, +Z direction, and −Z direction. In other words, the channel 50 communicates with the outside of the periodic structure 11. Therefore, a fluid can pass through the channel 50. The channel 50 may open to at least two end portions of the periodic structure 11 in the +X direction, −X direction, +Y direction, −Y direction, +Z direction, and −Z direction.

For example, in the case of the three-dimensional object 10 being a catalyst, an intended fluid passes through the channel 50. In this case, the three-dimensional object 10 promotes a chemical reaction of the fluid contacting with the inner surface 50a of the channel 50. The exposed surfaces of the columnar members 21 and the connections 22 form the inner surface 50a of the channel 50. Typically, the larger the surface area of the inner surface 50a is, the more the fluid chemical reaction advances in the three-dimensional object 10.

The columnar members 21 of the stepped structures 31 and 32 are connected to each other to be in a stepwise form. The inner surface 50a of the channel 50 thus has a stepwise form. Furthermore, the lower surface 21b and the side surface 21c of each of the columnar members 21 protrude outward. Because of this, the surface area of the inner surface 50a of the channel 50 is larger than, for example, that of a lattice-form three-dimensional object including a smooth grid or spiral part.

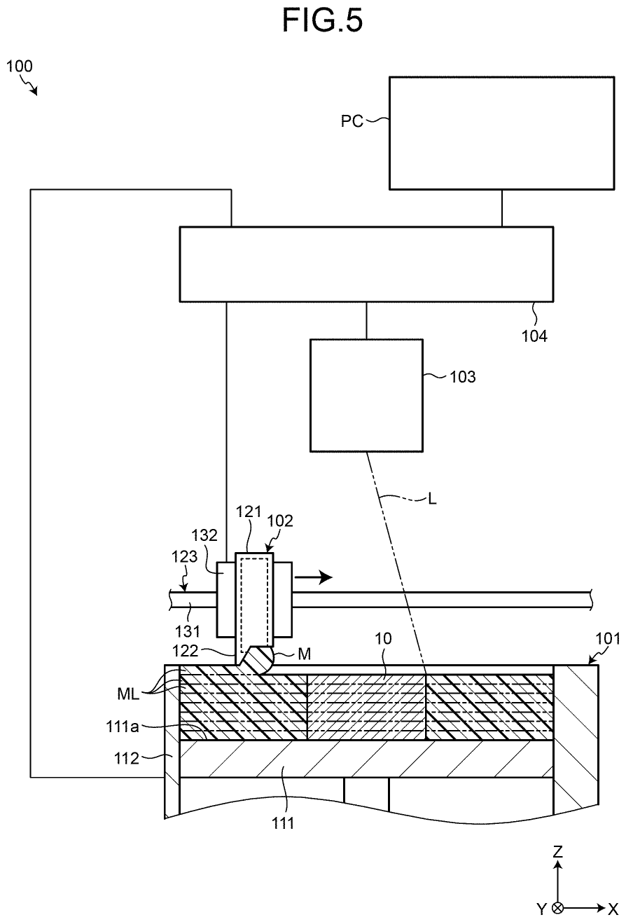

Hereinafter, some examples of a manufacturing method (additive manufacturing method) of the three-dimensional object 10 are illustrated with reference to FIGS. 5 to 7. The method of manufacturing the three-dimensional object 10 is not limited to the following methods, and other methods may be used.

FIG. 5 is an exemplary cross-sectional view schematically illustrating a three-dimensional printer 100 of the present embodiment. The three-dimensional printer 100 is a device that additively manufactures a three-dimensional object 10 from a material M. The material M is, for example, a slurry containing ceramic particles, a photocurable resin (photopolymer), and an additive such as a dispersant. The material M is not limited to this example.

The three-dimensional printer 100 of the present embodiment includes a stage 101, a material supply device 102, an optical device 103, and a control device 104. The three-dimensional printer 100 is not limited to this example.

The stage 101 includes a table 111 and a peripheral wall 112. The table 111 is, for example, a plate material extending along the X-Y plane. The shape of the table 111 is not limited thereto. The table 111 has an upper surface 111a. The upper surface 111a is a substantially flat surface facing approximately in the +Z direction. The peripheral wall 112 extends in the Z direction and has a cylindrical shape to surround the table 111. The table 111 can be moved into the peripheral wall 112 in the Z direction by using various devices, such as hydraulic elevators.

The material supply device 102 includes a tank 121, a blade 122, and a moving device 123. The tank 121 stores the material M. The tank 121 is provided with a slit to be able to supply the material M to the upper surface 111a of the table 111 through the slit. The blade 122 protrudes from the tank 121 toward the upper surface 111a. The blade 122 extends along the slit in the tank 121.

The moving device 123 includes a rail 131 and a moving mechanism 132. The rail 131 extends in the X direction, for example. The moving mechanism 132 is attached to the tank 121. The moving mechanism 132 can move the tank 121 and the blade 122 along the rail 131 in a parallel manner.

The moving device 123 changes positions of the tank 121 and the blade 122 relative to the stage 101. The moving device 123 may move the stage 101 relative to the tank 121 and the blade 122, for example.

The optical device 103 includes various components, such as a light source with an oscillating element to emit a laser beam L, a conversion lens that converts the laser beam L into a collimated beam, a convergence lens that converges the laser beam L, and a galvanometer mirror for moving an irradiation position of the laser beam L. In other words, the optical device 103 can emit the laser beam L. The optical device 103 can change the power density of the laser beam L.

The laser beam L is an example of light and an energy beam. The light is not limited to visible light. For example, in the case of using the material M containing an ultraviolet curable resin, the laser beam L may be an ultraviolet laser.

The optical device 103 is placed above the stage 101. The optical device 103 may be disposed in another location. The optical device 103 uses the conversion lens to convert the laser beam L emitted by the light source into a collimated beam. The optical device 103 causes the laser beam L to be reflected by the tilt-angle changeable galvanometer mirror and converged by the convergence lens, to emit the laser beam L to a desired position.

The control device 104 is electrically connected to the stage 101, the material supply device 102, and the optical device 103. The control device 104 is, for example, a computer, and includes various electronic components such as CPU, ROM, RAM, and external storage device.

The control device 104 reads out a computer program stored in ROM or the external storage device and executes the computer program to control the stage 101, the material supply device 102, and the optical device 103. The three-dimensional printer 100 additively manufactures the three-dimensional object 10 under the control (computer program) of the control device 104. The control device 104 can also communicate with an external personal computer PC, for example. The three-dimensional printer 100 and the personal computer PC can be included in an additive manufacturing system.

In one example of additive manufacturing performed by the three-dimensional printer 100 as above, the personal computer PC first inputs, for example, STL data for the three-dimensional object 10 to the control device 104. The control device 104 generates, from the STL data, manufacture data based on which the three-dimensional printer 100 manufactures the three-dimensional object 10. The manufacture data includes, for example, a moving command for the moving device 123, a command for the optical device 103 to emit the laser beam L, and an elevating and descending command for the table 111. The generated manufacture data is stored in, for example, the RAM or storage device of the control device 104.

Next, the moving device 123 of the material supply device 102 moves the tank 121 and the blade 122. As a result, the material M is supplied from the tank 121 to the upper surface 111a of the table 111. Furthermore, the material M is leveled by the blade 122. As a result, a layer ML of the material M is formed. The layer ML of the material M contains a photocurable resin of the material M.

Next, the control device 104 controls the optical device 103 to emit the laser beam L to the material M for forming the layer ML. The control device 104 determines a position to be irradiated with the laser beam L based on the manufacture data.

When irradiated with the laser beam L, a part of the layer ML is cured due to the curing action of the photocurable resin. This forms at least one columnar member 21 in the layer ML. A layer ML including no columnar member 21 may be produced.

When the optical device 103 completes emitting the laser beam L to the layer ML, the table 111 moves downward a predetermined distance. The moving distance of the table 111 is substantially equal to the thickness of the layer ML. The moving device 123 then moves the tank 121 and the blade 122 again. Thereby, a new layer ML is formed on the layer ML.

As described above, the material supply device 102 repeats forming the layer ML and forming the columnar member 21 in the layer ML by curing at least a part of the layer ML. In this way, the three-dimensional printer 100 forms the three-dimensional object 10 including the periodic structure 11.

In leveling the material M, the blade 122 causes a force on the cured part (columnar member 21) of the layer ML below in a direction orthogonal to the Z direction. In view of this, in the plurality of layers ML, the columnar members 21 are connected to each other to be in a stepwise form. As a result, during the additive manufacturing process the three-dimensional object 10 can maintain a strength against the force of the blade 122 and is not deformed.

The formed three-dimensional object 10 is buried in the uncured material M. The three-dimensional object 10 is thus washed to remove the uncured material M. For example, the uncured material M is removed by a chemical solution such as ethanol.

The formed three-dimensional object 10 includes the material M containing not only ceramics particles as the material of the three-dimensional object 10 but also the cured resin. The resin is removed from the three-dimensional object 10 by, for example, degreasing.

Next, the three-dimensional object 10 is transported to, for example, a furnace, and is heated in the furnace to fire the ceramics in the material M. This completes the additive manufacturing of the three-dimensional object 10 using ceramics.

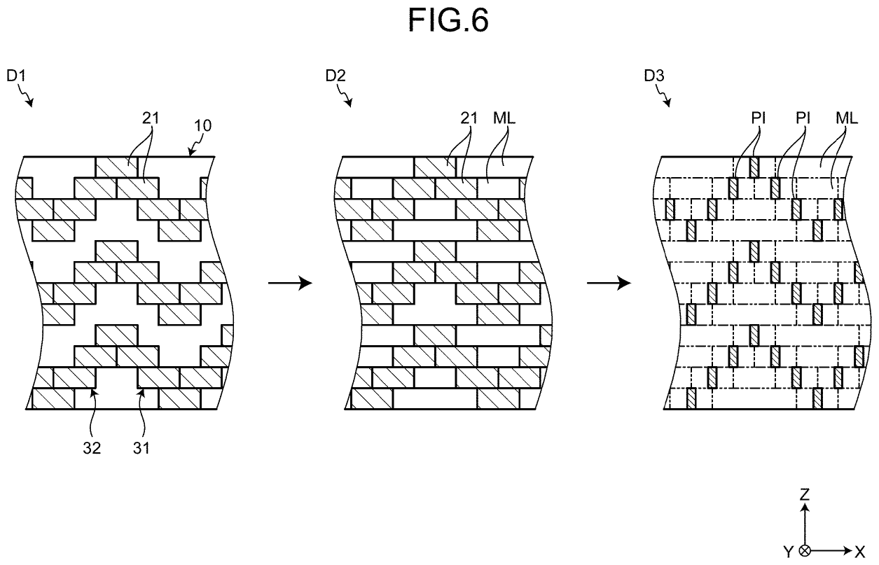

FIG. 6 is an exemplary diagram schematically illustrating various data in the present embodiment. In the additive manufacturing described above, the control device 104 generates manufacture data for the three-dimensional printer 100 to produce the three-dimensional object 10, for example, as described below. A method of generating manufacture data is not limited to the following methods. The personal computer PC may also generate the manufacture data.

For example, the personal computer PC first inputs model data D1 to the control device 104. The model data D1 is, for example, STL data. That is, the model data D1 is data representing the three-dimensional shape of the three-dimensional object 10 including the periodic structure 11. The model data D1 is not limited to the STL data, and may be other data such as CAD data.

The model data D1 represents the columnar members 21 as cylinders. Specifically, the model data D1 represents the lower surfaces 21b of the columnar members 21 as flat surfaces and the side surfaces 21c as cylindrical curved surfaces. The model data D1 is not limited to this example.

Next, the control device 104 divides or slices the three-dimensional shape of the acquired model data D1 into a plurality of layers. The control device 104 converts (rasterizes or converts into pixels) the slices of the three-dimensional shape into a group of points or cuboids (pixels), for example, to generate slice data D2. The slice data D2 corresponds to the shape of a part (columnar member 21) of each of the layers ML of the three-dimensional object 10. As described above, the control device 104 generates the slice data D2 from the acquired model data D1.

Next, the control device 104 generates manufacture data D3 including the command to emit the laser beam L to the layers ML, from the slice data D2. Portions to be irradiated with the laser beam L in the manufacture data D3 is smaller than the columnar members 21 in the layers ML.

The manufacture data D3 in FIG. 6 illustrates portions of the layers ML to be cured by irradiation of the laser beam L according to the command included in the manufacture data D3. That is, in the case of curing only the portions irradiated with the laser beam L in the layers ML, the three-dimensional object 10 will have a shape represented by the manufacture data D3 in FIG. 6.

The control device 104 may generate slice data including size-reduced columnar members 21 illustrated as the manufacture data D3 in FIG. 6 before generating the manufacture data D3 including the command to emit the laser beam L. In this case, the control device 104 generates the manufacture data D3 including the command to emit the laser beam L to the layers ML from the slice data.

In the manufacture data D3, portions of one layer ML to be irradiated with the laser beam L and portions of another layer ML to be formed next and irradiated with the laser beam L are apart from each other in a direction intersecting with the Z direction (+Z direction). In other words, in the manufacture data D3, portions of two adjacent layers ML to be irradiated with the laser beam L are apart from each other.

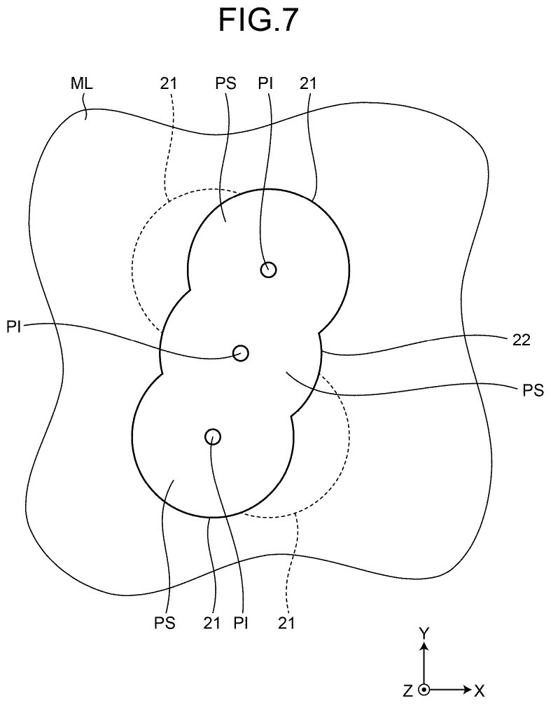

FIG. 7 is an exemplary plan view schematically illustrating a part of one layer ML in the additive manufacturing process of the present embodiment. FIG. 7 illustrates, for example, a layer ML in which two columnar members 21 and a connection 22 are formed. Furthermore, FIG. 7 illustrates, with a dashed line, columnar members 21 formed in one layer ML below.

The columnar members 21 and the connections 22 are formed based on the manufacture data D3. The portions PI irradiated with the laser beam L in the layer ML are smaller than both of the columnar members 21 and the connections 22 to be formed. In other words, the portions PI irradiated with the laser beam L in the layers ML are smaller in area than the upper surfaces 21a of the columnar members 21 and the upper surfaces 22a of the connections 22.

By irradiation of the laser beam L to the layers ML, not only the portions PI irradiated with the laser beam L but also portions PS surrounding the portions PI are cured. The columnar members 21 and the connections 22 are formed by curing the portions PI and the surrounding portions PS (surplus curing). That is, forming the columnar members 21 and connections 22 includes curing the portions PI and the surrounding portions PS by irradiating the portions PI of the layer ML with the laser beam L.

The control device 104 generates the manufacture data D3 so that the differences in outer diameter between the portions PS to be cured by surplus curing and the corresponding columnar members 21 or connections 22 fall within a predetermined range. For example, the control device 104 calculates the outer diameter of each of the portions PI to be irradiated with the laser beam L by subtracting a distance to be cured by surplus curing from the outer diameter of each of the columnar members 21 in the slice data D2.

As described above, in the manufacture data D3, the portions of the two adjacent layers ML to be irradiated with the laser beam L are separated from each other. However, surplus curing causes the columnar members 21 of the two adjacent layers ML to partially overlap each other, i.e., connect together to be in a stepwise form.

As a result of surplus curing, the lower surface 21b and the side surface 21c of each of the columnar members 21 become curved surfaces protruding outward. In addition, the surfaces of the columnar members 21 may be worn by, for example, washing. Because of this, the manufactured columnar members 21 illustrated in FIG. 4 and the columnar members 21 in the model data D1 illustrated in FIG. 6 are different in shape from each other.

In the three-dimensional object 10 according to the embodiment described above, the periodic structure 11 includes the columnar members 21. The columnar members 21 form the stepped structures 31 and 32 connected to each other. In each of the stepped structures 31 and 32, the columnar members 21 are connected together in a stepwise form along the polygonal spiral trajectory around the unit axis Ax. In each of the stepped structures 31 and 32 the unit axis Ax extends in the +Z direction. Each of the stepped structures 31 and 32 is provided with the unit channels 45, 46, 47, and 48 extending along the connected columnar members 21 of a stepwise form. The periodic structure 11 is provided with the channel 50 in communication with the outside of the periodic structure 11. The channel 50 includes the unit channels 45, 46, 47, and 48 extending along the stepped structures 31 and 32. Due to the stepwise form of the connected columnar members 21, the channel 50 can have the inner surface 50a with a larger surface area. Further, due to the stepwise form of the connected columnar members 21 along the polygonal spiral trajectory, the unit channels 45, 46, 47, and 48 can be spirally formed and regularly connected to each other. Such an arrangement allows the fluid to easily pass through the channel 50. In the case of the three-dimensional object 10 being a catalyst, for example, the channel 50 having a larger inner surface area allows the fluid to easily pass therethrough, leading to improving the catalyst in performance. For another example, in additive manufacturing of the three-dimensional object 10, the channel 50 allows the fluid to smoothly pass therethrough to be able to prevent an uncured part of the material M from remaining in the channel 50 after curing.

It can be typically said that the three-dimensional object 10 having the channel 50 with the inner surface 50a of a larger surface area more effectively functions as a catalyst, a gas-liquid separator, a radiator, or other application. By narrowing the channel 50, the three-dimensional object 10 can be provided with a larger number of the channels 50, increasing the inner surface 50a of the channel 50 in surface area. However, an uncured part of the material M is more likely to remain in the narrower channel 50. Meanwhile, the three-dimensional object 10 of the present embodiment is provided with the channel 50 through which the fluid can smoothly pass, as described above. Thus, it is possible to prevent an uncured part of the material M from remaining in the channel 50 in the three-dimensional object 10 after curing.

Each of the columnar members 21 has the upper surface 21a facing the +Z direction. At least one of the columnar members 21 is connected to the upper surface 21a of another one of the columnar members 21. Such a connection enables the inner surface 50a of the channel 50 to have a sharper stepwise shape and a larger surface area.

Each of the columnar members 21 has the lower surface 21b opposite to the upper surface 21a and the side surface 21c extending between the upper surface 21a and the lower surface 21b. The side surface 21c is a curved surface protruding in the direction intersecting with the +Z direction. This can increase the inner surface 50a of the channel 50 in surface area.

At least two of the columnar members 21 have the upper surfaces 21a at the same position in the +Z direction and are apart from each other in a direction orthogonal to the +Z direction. This can form wider unit channels 45, 46, 47, and 48. Thus, the fluid can easily pass through the channel 50.

The stepped structures 31 and 32 are connected to each other in a direction intersecting with the +Z direction. The unit channels 45, 46, 47, and 48 along one of the stepped structures 31 and 32 includes a unit channel 45 extending in the upper left direction intersecting with the +Z direction. The unit channels 45, 46, 47, and 48 of another one of the stepped structures 31 and 32 connected to the one of the stepped structures 31 and 32 includes a unit channel 47 extending in the upper right direction intersecting with the +Z direction and the upper left direction. The unit channel 45 is connected to the unit channel 47. That is, the unit channel 45 and the unit channel 47 meander in the channel 50. Thus, the inner surface 50a of the channel 50 can be larger in surface area.

One of the stepped structures 31 and 32 is connected to another one of the stepped structures 31 and 32 in the X direction orthogonal to the +Z direction. The one of the stepped structures 31 and 32 is further connected to still another one of the stepped structures 31 and 32 in the Y direction orthogonal to the +Z direction and the X direction. That is, the connected stepped structures 31 and 32 form a lattice pattern. As a result, the three-dimensional object 10 and the channel 50 widened in the X direction and the Y direction can be provided.

In each of the stepped structures 31 and 32, the columnar members 21 are connected together in a stepwise form along double spiral trajectories around the unit axis Ax. The periodic structure 11 includes the connections 22. In each of the stepped structures 31 and 32, the connections 22 work to connect between the connected columnar members 21 of a stepwise form along one of the double spiral trajectories and the connected columnar members 21 of a stepwise form along the other trajectory. By such connections, the inner surface 50a of the channel 50 can be enlarged in surface area. The three-dimensional object 10 can be improved in strength owing to the connections 22 each connecting two columnar members 21.

The additive manufacturing method of the three-dimensional object 10 in the present embodiment as mentioned above includes forming the layer ML, forming at least one columnar member 21 in the layer ML by curing at least a part of the layer ML, and repeating the layer forming and the columnar member forming to form the periodic structure 11. As such, the periodic structure 11 is manufactured by additive manufacturing. In the periodic structure 11, the inner surface 50a of the channel 50 can have a larger surface area, leading to preventing an uncured part of the material M from remaining in the channel 50 after curing in the additive manufacturing process.

The layer ML contains a photocurable resin. Forming at least one columnar member 21 includes curing the portion PI of the layer ML and the surrounding portion PS of the portion PI by irradiation of the laser beam L to the portion PI. That is, the columnar member 21 is formed not only by curing the portion PI by irradiation of the laser beam L but also by propagation of the curing action (surplus curing) to the surround of the portion PI. As described above, taking surplus curing into account, the additive manufacturing method of the present embodiment can prevent the channel 50 from being closed by surplus curing.

The manufacture data D3 is generated from the model data D1 representing the shape of the periodic structure 11. The manufacture data D3 includes the command to emit the laser beam L to the portion PI of the layer ML, the portion smaller in size than one columnar member 21. At least one columnar member 21 is formed based on the manufacture data D3. That is, the manufacture data D3 with surplus curing taken into account is generated from the model data D1 representing the shape of the periodic structure 11. As a result, the additive manufacturing method of the present embodiment can reduce the size of the manufacture data D3.

The manufacture data D3 represents that the portions of the layer ML to be irradiated with the laser beam L and portions of another layer ML to be formed next and irradiated with the laser beam L are apart from each other in a direction intersecting with the +Z direction. The additive manufacturing method of the present embodiment can thus set portions to be irradiated with the laser beam L in a distributed manner, thereby reducing the size of the manufacture data D3.

Modification

In the embodiment described above, the three-dimensional object 10 is made of ceramics, and the material M contains the ceramics particles and the photocurable resin. On the other hand, in one modification, the three-dimensional object 10 is made of a metal, and the material M contains a powdered metal. In this case, the three-dimensional printer 100 emits the laser beam L to the layer ML formed of the material M to sinter parts in the layer ML. Means for sintering the portions in the layer ML is not limited to the laser beam L, and the three-dimensional printer 100 may also sinter the portions in the layer ML by other means such as microwaves.

In the modification, the columnar members 21 and the connections 22 are also formed based on the manufacture data D3. Therefore, each of the portions PI irradiated with the laser beam L in the layer ML are smaller than each of the formed columnar members 21 and the formed connections 22.

In a case in which the layer ML is irradiated with the laser beam L, not only the portions PI irradiated with the laser beam L but also the portions PS each of which surrounds each of the portions PI are sintered. Each of the columnar members 21 and each of the connections 22 are formed by sintering the portions PI and sintering the surrounding portions PS (temporary sintering). That is, the formation of the columnar members 21 and connections 22 includes irradiation of the portions PI in the layers ML with the laser beam L to sinter the portions PI and the portions PS each of which surrounds each of the portions PI.

The control device 104 generates the manufacture data D3 so that the difference between an outer diameter of each of the portions PS sintered by temporary sintering and an outer diameter of each of the corresponding columnar members 21 or connections 22 is within a predetermined range. For example, the control device 104 calculates the outer diameter of each of the portions PI irradiated with the laser beam L by subtracting a distance to be sintered by temporary sintering from the outer diameter of each of the columnar members 21 in the slice data D2.

In the modification described above, the layer ML contains a powdered metal. Forming at least one columnar member 21 includes sintering the portion PI of the layer ML and the portions PS surrounding the portion PI by irradiation of the laser beam L to the portion PI. That is, the columnar members 21 are formed not only by sintering the portions PI irradiated with the laser beam L but also by propagation of the sintering (temporary sintering) to the surrounds of the irradiated portions PI. As described above, the additive manufacturing method of the present embodiment takes temporary sintering into account, therefore, it can prevent the channel 50 from being closed due to temporary sintering.

The manufacture data D3 is generated from the model data D1 representing the shape of the periodic structure 11. The manufacture data D3 includes the command to emit the laser beam L to a part, of the layer ML, smaller in size than one columnar member 21. At least one columnar member 21 is formed based on the manufacture data D3. That is, the manufacture data D3 is generated from the model data D1 representing the shape of the periodic structure 11, with temporary sintering taken into account. As a result, the additive manufacturing method of the present embodiment can reduce the size of the manufacture data D3.

The manufacture data D3 represents that portions PI of the layer ML to be irradiated with the laser beam L and portions PI of another layer ML to be formed next and irradiated with the laser beam L are apart from each other in a direction intersecting with the +Z direction. Thus, the portions PI to be irradiated with the laser beam L are set in a distributed manner. As such, the additive manufacturing method of the present embodiment can reduce the size of the manufacture data D3.

In the above description, the word “prevent” means, for example, preventing the occurrence of an event, action, or effect, or reducing a degree of an event, action, or effect.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional object comprising:
a periodic structure including a plurality of unit objects which form a plurality of stepped structures connected to each other, wherein
in each of the stepped structures, the unit objects are connected together in a stepwise form along a polygonal spiral trajectory around a unit axis,
in each of the stepped structures, the unit axis extends in a first direction,
the stepped structures are each provided with a unit channel extending along the connected unit objects of the stepwise form, and
the periodic structure is provided with a channel in communication with an outside of the periodic structure, the channel including the unit channels.

2. The three-dimensional object according to claim 1, wherein
each of the unit objects has a flat surface facing the first direction, and
at least one of the unit objects is connected to the flat surface of another one of the unit objects.

3. The three-dimensional object according to claim 2, wherein
each of the unit objects has a lower surface opposite to the flat surface and a side surface extending between the flat surface and the lower surface, and
the side surface is a curved surface protruding in a direction intersecting with the first direction.

4. The three-dimensional object according to claim 2, wherein
at least two of the unit objects have the flat surfaces at a same position in the first direction and are apart from each other in a direction orthogonal to the first direction.

5. The three-dimensional object according to claim 1, wherein
the stepped structures are connected to each other in a direction intersecting with the first direction,
the unit channel along one of the stepped structures includes a first unit channel extending in a second direction intersecting with the first direction,
the unit channel along another one of the stepped structures connected to the one of the stepped structures includes a second unit channel extending in a third direction intersecting with the first direction and the second direction, and
the first unit channel is connected to the second unit channel.

6. The three-dimensional object according to claim 1, wherein one of the stepped structures is connected to:
another one of the stepped structures in a fourth direction orthogonal to the first direction, and
still another one of the stepped structures in a fifth direction orthogonal to the first direction and the fourth direction.

7. The three-dimensional object according to claim 1, wherein
in each of the stepped structures, the unit objects are connected together in a stepwise form along double spiral trajectories around the unit axis, and
the periodic structure includes a connection connecting between the connected unit objects of the stepwise form along one of the double spiral trajectories and the connected unit objects of the stepwise form along the other one of the double spiral trajectories in each of the stepped structures.

8. An additive manufacturing method of a three-dimensional object comprising:
forming a layer;
forming at least one unit object in the layer by curing at least a part of the layer, and
repeating the layer forming and the unit object forming to form a periodic structure including a plurality of unit objects, wherein
the unit objects form a plurality of stepped structures connected to each other,
in each of the stepped structures, the unit objects are connected together in a stepwise form along a polygonal spiral trajectory around a unit axis,
in each of the stepped structures, the unit axis extends in a first direction,
the stepped structures are each provided with a unit channel extending along the connected unit objects of the stepwise form, and
the periodic structure is provided with a channel in communication with an outside of the periodic structure, the channel including the unit channels.

9. The additive manufacturing method according to claim 8, wherein
the layer contains a photocurable resin, and
the forming at least one unit object includes curing a part of the layer and a surround of the part by irradiating the part of the layer with light.

10. The additive manufacturing method according to claim 9, further comprising:
generating manufacture data from shape data of the periodic structure, the manufacture data including a command to emit the light to a part of the layer, the part smaller in size than the unit object, wherein
the forming at least one unit object includes forming at least one unit object based on the manufacture data.

11. The additive manufacturing method according to claim 10, wherein
the manufacture data represents that the part of the layer irradiated with the light and a part of another layer to be formed next and irradiated with the light are apart from each other in a direction intersecting with the first direction.

12. The additive manufacturing method according to claim 8, wherein
the layer contains a powdered metal, and
the forming at least one unit object includes sintering a part of the layer and a surround of the part by irradiating the part of the layer with an energy beam.

13. The additive manufacturing method according to claim 12, further comprising:
generating manufacture data from shape data of the periodic structure, the manufacture data including a command to emit the energy beam to a part of the layer, the part smaller in size than the unit object, wherein
the forming at least one unit object includes forming at least one unit object based on the manufacture data.

14. The additive manufacturing method according to claim 13, wherein
the manufacture data represents that the part of the layer irradiated with the energy beam and a part of another layer to be formed next and irradiated with the energy beam are apart from each other in a direction intersecting with the first direction.
